(19) United States
(12) Patent Application Publication
(10) Pub. No.: US 2025/0376989 A1
(43) Pub. Date: Dec. 11, 2025

(54) DESWIRLERS IN REFRIGERANT COMPRESSORS

(71) Applicant: Danfoss A/S, Nordborg (DK)

(72) Inventors: Lin Xiang Sun, Tallahassee, FL (US); Jin Yan, Tallahassee, FL (US); Tadeu Mendonca Fagundes, Tallahassee, FL (US)

(21) Appl. No.: 18/876,779

(22) PCT Filed: May 22, 2023
(86) PCT No.: PCT/US2023/023088

§ 371 Date: Dec. 19, 2024

Related U.S. Application Data
(60) Provisional application No. 63/355,331, filed on Jun. 24, 2022.

(51) Int. Cl. F04D 29/44; F04D 17/10; F25B 31/02

(52) U.S. Cl. CPC F04D 29/444; F04D 17/10; F25B 31/02

(57) ABSTRACT

A refrigerant compressor includes a discharge portion, and a deswirler disposed at the discharge portion. The deswirler includes a hollow cylinder, which includes an inner diameter surface and a center axis. A plurality of vanes extend radially inward from the inner diameter surface toward the center axis.

### CROSS-REFERENCED TO RELATED APPLICATION

This application is a 371 application of International Application No. PCT/US2023/023088, filed May 22, 2023, which claims priority to U.S. Provisional Application No. 63/355,331, which was filed on Jun. 24, 2022.

### BACKGROUND

Refrigerant compressors are used to circulate refrigerant in a chiller via a refrigerant loop. Refrigerant loops are known to include a condenser, an expansion device, and an evaporator. The compressor compresses the fluid, which then travels to a condenser, which in turn cools and condenses the fluid. The refrigerant then goes to an expansion device, which decreases the pressure of the fluid, and to the evaporator, where the fluid is vaporized, completing a refrigeration cycle.

### SUMMARY

A refrigerant compressor according to an example of this disclosure includes a discharge portion, and a deswirler disposed at the discharge portion. The deswirler includes a hollow cylinder, which includes an inner diameter surface and a center axis. A plurality of vanes extend radially inward from the inner diameter surface toward the center axis.

In a further example of the foregoing, an axial width of each of the plurality of vanes tapers as it extends radially inward.

In a further example of any of the foregoing, a circumferential width of each of the plurality of vanes tapers as it extends radially inward.

In a further example of any of the foregoing, the taper is linear.

In a further example of any of the foregoing, each of the plurality of vanes tapers to a tip, and the tips are free-standing.

In a further example of any of the foregoing, a circumferential width of each of the plurality of vanes tapers as it extends radially inward.

In a further example of any of the foregoing, the taper is linear.

In a further example of any of the foregoing, the plurality of vanes consists of seven vanes.

In a further example of any of the foregoing, each of the plurality of vanes extends from its leading edge to its trailing edge in a direction substantially parallel to the center axis.

In a further example of any of the foregoing, each of the plurality of vanes is plane symmetrical across a plane, and the center axis lies in the plane.

In a further example of any of the foregoing, a base of the cylinder is attached to the discharge portion.

In a further example of any of the foregoing, an axial width of each of the plurality of vanes tapers linearly as it extends radially inward, each of the plurality of vanes tapers to a tip, and the tips are free-standing, a circumferential width of each of the plurality of vanes tapers linearly as it extends radially inward, each of the plurality of vanes extends from its leading edge to its trailing edge in a direction substantially parallel to the center axis.

A method according to an example of this disclosure includes providing a deswirler fluidly between a discharge portion of a compressor and a condenser. The deswirler includes a hollow cylinder, which includes an inner diameter surface and a center axis. A plurality of vanes extend radially inward from the inner diameter surface toward the center axis.

In a further example of the foregoing, a base of a cylinder is attached to the discharge portion.

In a further example of any of the foregoing, an axial width of each of the plurality of vanes tapers as it extends radially inward.

In a further example of any of the foregoing, each of the plurality of vanes tapers to a tip, and the tips are free-standing.

In a further example of any of the foregoing, a circumferential width of each of the plurality of vanes tapers as it extends radially inward.

In a further example of any of the foregoing, each of the plurality of vanes tapers to a tip, and the tips are free-standing.

In a further example of any of the foregoing, an axial width of each of the plurality of vanes tapers linearly as it extends radially inward, each of the plurality of vanes tapers to a tip, and the tips are free-standing, a circumferential width of each of the plurality of vanes tapers linearly as it extends radially inward, each of the plurality of vanes extends from its leading edge to its trailing edge in a direction substantially parallel to the center axis.

These and other features may be best understood from the following specification and drawings, the following of which is a brief description.

### BRIEF DESCRIPTION OF THE DRAWINGS

FIG. 1 schematically illustrates a refrigerant system.

FIG. 2 illustrates an example compressor.

FIG. 3 illustrates an example deswirler.

FIG. 4 illustrates a cross sectional view of the example deswirler in FIG. 3.

FIG. 5 illustrates an example impeller of the example compressor.

### DETAILED DESCRIPTION

This disclosure relates generally to refrigerant compressors, and more particularly to deswirlers at a discharge portion of a refrigerant compressor. The systems and methods disclosed herein have been found to decrease the noise output of refrigerant compressors.

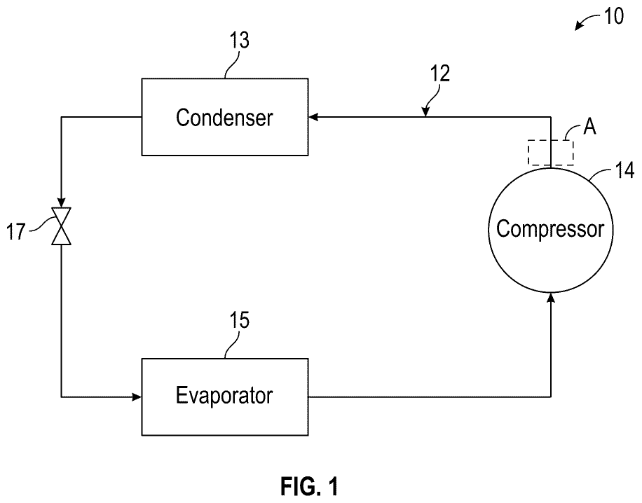

FIG. 1 schematically illustrates a refrigerant cooling system 10. The refrigerant system 10 includes a main refrigerant loop, or circuit, 12 in communication with a compressor or multiple compressors 14, a condenser 13, an evaporator 15, and an expansion device 17. This refrigerant system 10 may be used in a chiller or heat pump, for example. While a particular example of the refrigerant system 10 is shown, this disclosure extends to other refrigerant system configurations. For instance, the main refrigerant loop 12 can include an economizer downstream of the condenser 13 and upstream of the expansion device 17. The refrigerant cooling system 10 may be an air conditioning system, for example.

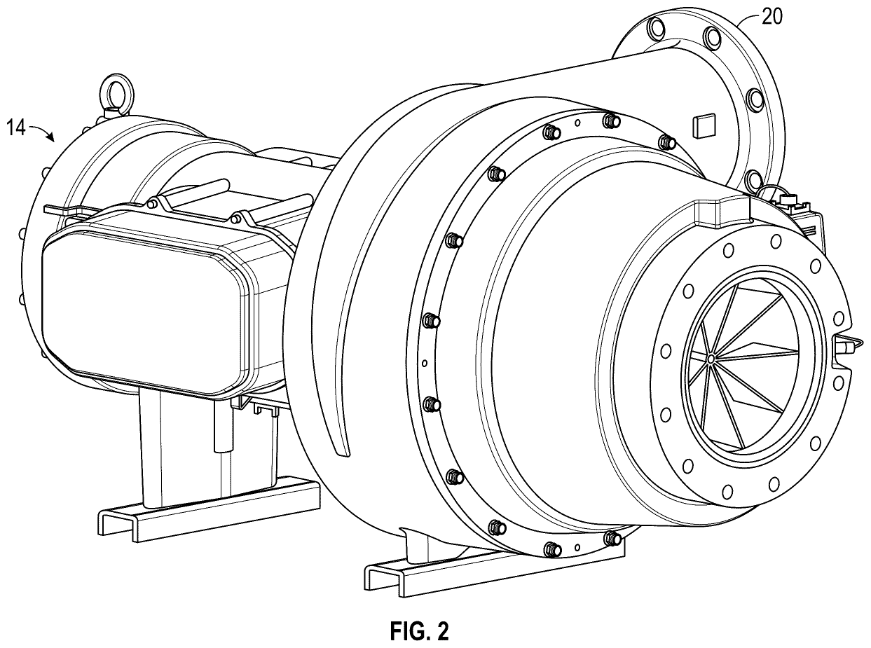

FIG. 2 illustrates an example compressor 14 including a discharge portion 20 where refrigerant exits the compressor 14 before flowing to the condenser 13 (see FIG. 1). The example discharge portion 20 is where refrigerant exits the compressor 14, as opposed to a location between compressor stages. Although an example compressor 14 is shown, other types of compressors may benefit from this disclosure.

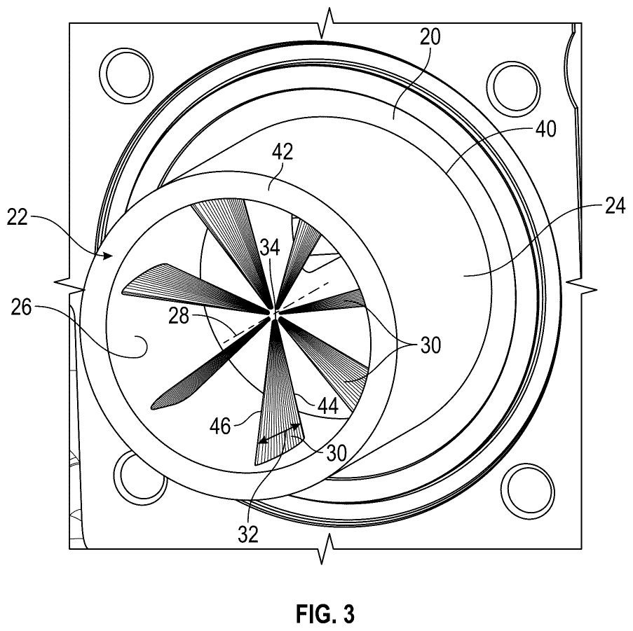

FIG. 3 illustrates an example deswirler 22, which may be provided at the area A (FIG. 1) fluidly between the compressor 14 and the condenser 13. In some examples, the deswirler 22 may be attached to the discharge portion 20 (FIG. 2) of the compressor 14. The example deswirler 22 includes a hollow cylinder 24 having a center axis 28 and an inner diameter surface 26. A plurality of circumferentially spaced vanes 30 extend radially inward from the inner diameter surface 26 toward the center axis 28. The discharge flow from the compressor 14 enters the deswirler 22 with leftover swirl from the input rotational energy produced by the compressor impeller (not shown).

As the flow enters the deswirler 22 from the compressor 14, it is oriented by the guiding vanes 30, orienting the flow and modifying it into a more uniform flow that does not have an oscillatory pattern. The steady orientation of the discharge flow from the deswirler 22 leads to a decrease in overall noise output from the compressor 14, as most of the compressor output noise comes from the aforementioned oscillatory flow pattern coming from the compressor discharge portion 20.

In some examples, as shown, one base 40 of the cylinder 24 is attached to the discharge portion 20, and an opposing base 42 of the cylinder 24 provides a refrigerant output of the deswirler 22. That is, refrigerant flows through the example deswirler 22 within the inner diameter surface 26 and across the vanes 30 in the direction from the base 40 to the base 42.

In some examples, as shown, an axial width 32 of each of the vanes 30 from the leading edge 44 to the trailing edge 46 tapers as it extends radially inward. In some examples, the taper is linear. In some examples, as shown, each of the plurality of vanes tapers to a tip 34, and the tips 34 are free-standing. That is, the tips 34, are not joined, connected, or mounted or attached to anything in some examples. An axially extending opening along the center axis 28 is provided radially inward of the example tips 34, and the tips 34 are not connected circumferentially.

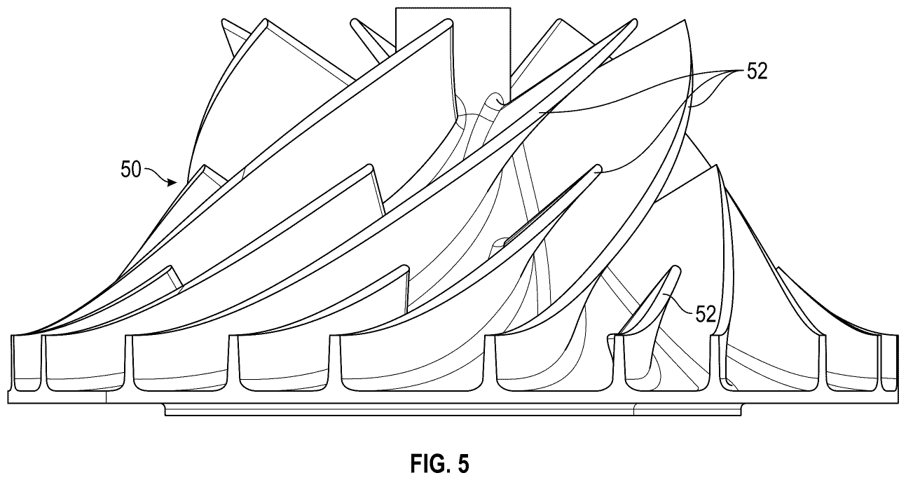

Although seven vanes 30 are shown in the example, more or fewer vanes 30, including odd and even numbers, may be utilized. As shown in the example in FIG. 5, with continued reference to FIG. 3, the example compressor 14 includes an impeller 50 including a number of impeller blades 52. In some examples, the number of vanes 30 is different from the number of impeller blades 52 because Applicant has discovered that having the same number of vanes 30 and impeller blades 52 can lead to similar harmonic frequencies between them and cause resonance, which may increase the noise instead of dampening it. Other impeller types and configurations may be utilized and may benefit from this disclosure.

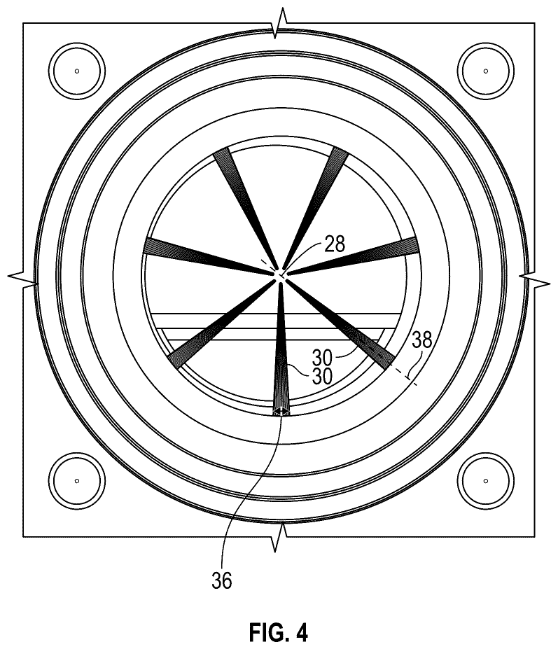

FIG. 4 illustrates a cross sectional view of the example deswirler 22. In some examples, the circumferential thickness 36 of each vane 30 tapers as it extends radially inward. In some examples, the taper is linear. In some examples, as shown, at any given radial location, the axial thickness 32 of the vane (FIG. 3) is greater than the circumferential thickness 36 of the vane 30.

In some examples, as shown, the vanes 30 are oriented to be substantially parallel to the center axis 28. In some examples, as shown, the vanes 30 are oriented parallel to the incoming flow at the discharge 20 of the compressor 14.

In some examples, as shown in FIG. 3, the vanes 30 extend from their respective leading edges 44 to their respective trailing edges 46 in a direction substantially parallel (±5 degrees) to the center axis 28.

In some examples, as shown in FIG. 4, each vane 30 is plane symmetrical across a plane 38, and the center axis 28 lies in the plane 38. In some examples, as shown, the surfaces of the vanes 30 include a curvature.

A method may be said to include providing a deswirler fluidly between a discharge portion of a compressor and a condenser, the deswirler including a hollow cylinder including an inner diameter surface and a center axis, and a plurality of vanes extending radially inward from the inner diameter surface toward the center axis.

A refrigerant compressor may be said to include a discharge portion and a deswirler at the discharge portion. The deswirler includes a hollow cylinder including an inner diameter surface and a center axis, and a plurality of vanes extend radially inward from the inner diameter surface toward the center axis.

Terms such as “generally,” “substantially,” and “about” are not intended to be boundaryless terms, and should be interpreted consistent with the way one skilled in the art would interpret those terms.

The foregoing description shall be interpreted as illustrative. A worker of ordinary skill in the art would understand that certain modifications could come within the scope of this disclosure. Various examples of the disclosure have been described. Any combination of the described systems, operations, or functions is contemplated. It is possible to use some of the components or features from any of the examples in combination with features or components from any of the other examples. For these reasons, the following claims should be studied to determine the true scope and content of this disclosure.

What is claimed is:

1. A refrigerant compressor, comprising:
a discharge portion; and
a deswirler disposed at the discharge portion, the deswirler including
a hollow cylinder including an inner diameter surface and a center axis, and
a plurality of vanes extending radially inward from the inner diameter surface toward the center axis.

2. The compressor of claim 1, wherein an axial width of each of the plurality of vanes tapers as it extends radially inward.

3. The compressor of claim 2, wherein each of the plurality of vanes tapers to a tip, and the tips are free-standing.

4. The compressor of claim 2, wherein a circumferential width of each of the plurality of vanes tapers as it extends radially inward.

5. The compressor of claim 2, wherein the taper is linear.

6. The compressor of claim 1, wherein each of the plurality of vanes tapers to a tip, and the tips are free-standing.

7. The compressor of claim 1, wherein a circumferential width of each of the plurality of vanes tapers as it extends radially inward.

8. The compressor of claim 7, wherein the taper is linear.

9. The compressor of claim 1, wherein the plurality of vanes consists of seven vanes.

10. The compressor of claim 1, wherein each of the plurality of vanes extends from its leading edge to its trailing edge in a direction substantially parallel to the center axis.

11. The compressor of claim 1, wherein each of the plurality of vanes is plane symmetrical across a plane, and the center axis lies in the plane.

12. The compressor of claim 1, wherein a base of the cylinder is attached to the discharge portion.

13. The compressor of claim 1, wherein an axial width of each of the plurality of vanes tapers linearly as it extends radially inward, each of the plurality of vanes tapers to a tip, and the tips are free-standing, a circumferential width of each of the plurality of vanes tapers linearly as it extends radially inward, each of the plurality of vanes extends from its leading edge to its trailing edge in a direction substantially parallel to the center axis.

14. A method, comprising:
providing a deswirler fluidly between a discharge portion of a compressor and a condenser, the deswirler including:
a hollow cylinder including an inner diameter surface and a center axis, and
a plurality of vanes extending radially inward from the inner diameter surface toward the center axis.

15. The method of claim 14, comprising:
attaching a base of the cylinder to the discharge portion.

16. The method of claim 14, wherein an axial width of each of the plurality of vanes tapers as it extends radially inward.

17. The method of claim 16, wherein each of the plurality of vanes tapers to a tip, and the tips are free-standing.

18. The method of claim 16, wherein a circumferential width of each of the plurality of vanes tapers as it extends radially inward.

19. The method of claim 14, wherein each of the plurality of vanes tapers to a tip, and the tips are free-standing.

20. The method of claim 14, wherein an axial width of each of the plurality of vanes tapers linearly as it extends radially inward, each of the plurality of vanes tapers to a tip, and the tips are free-standing, a circumferential width of each of the plurality of vanes tapers linearly as it extends radially inward, each of the plurality of vanes extends from its leading edge to its trailing edge in a direction substantially parallel to the center axis.
